(19) United States
(12) Patent Application Publication
(10) Pub. No.: US 2022/0136961 A1
(43) Pub. Date: May 5, 2022

(54) METHOD FOR CALIBRATING A PHOTOMETRIC ANALYZER

(71) Applicant: Endress+Hauser Conducta GmbH+Co. KG, Gerlingen (DE)

(72) Inventors: Daniel Schweitzer, Remshalden (DE); Jonathan Weinbrenner, Schonaich (DE)

(21) Appl. No.: 17/519,909

(22) Filed: Nov. 5, 2021

(30) Foreign Application Priority Data
Nov. 5, 2020 (DE) 10 2020 129 213.9

(51) Int. Cl. G01N 21/27; G01N 21/78; G01N 35/00

(52) U.S. Cl. CPC G01N 21/274; G01N 2201/12746; G01N 35/00693; G01N 21/78

(57) ABSTRACT

The present disclosure discloses a method for calibrating a photometric analyzer which is designed to determine the silicate content of an analyte, comprising the steps of: detecting a first measurement point, with the steps of adding a first reagent to a sample of a first calibration standard, adding a second reagent to this sample, adding a third reagent to this sample; detecting a second measurement point, wherein the second measurement point differs from the first measurement point, with the steps of adding the second reagent to a sample of a second calibration standard, adding the first reagent to this sample, adding a third reagent to this sample; determining the zero point and the slope of the calibration line using the first and second measurement points.

### CROSS-REFERENCE TO RELATED APPLICATION

The present application is related to and claims the priority benefit of German Patent Application No. 10 2020 129 213.9, filed on Nov. 5, 2020, the entire contents of which are incorporated herein by reference.

### TECHNICAL FIELD

The present disclosure relates to a method for calibrating a photometric analyzer which is designed to determine the silicate content of an analyte.

### BACKGROUND

In process metrology, e.g. in chemical, biotechnological, pharmaceutical, and food technology processes, as well as in environmental metrology, such automatic analyzers, also called analytical apparatuses, are used for determining a measurand of a liquid sample. Analyzers may, for example, be used to monitor and optimize the cleaning performance of a sewage treatment plant, to monitor process water or drinking water, or to monitor the quality of foods. For example, the proportion of a certain substance, also called an analyte, is measured and monitored in a sample fluid, such as a liquid or a liquid mixture, an emulsion, a suspension, a gas, or a gas mixture. Analytes may, for example, be ions such as ammonium, phosphate, silicate or nitrate, calcium, sodium, or chloride, or biological or biochemical compounds, e.g. hormones, or even micro-organisms. Other parameters that are determined using analytical apparatuses in process metrology, such as in the field of water monitoring, are sum parameters such as total organic carbon (TOC), total nitrogen (TN), total phosphorus (TP), or chemical oxygen demand (COD). Analytical apparatuses may be designed as cabinet devices, for example. Presently, what is meant are analyzers for determining the silicate content.

The sample to be analyzed is often treated in analytical apparatuses in that it is mixed with one or more reagents so that a chemical reaction occurs in the reaction mixture. The reagents are preferably selected such that the reaction product is detectable by means of physical methods, e.g. by optical measurements, by means of potentiometric or amperometric sensors, or by a conductivity measurement. By means of a measuring sensor, measured values of a measurand that is correlated with the analytical parameter (such as COD) that is actually to be determined are detected accordingly. The chemical reaction may, for example, cause a coloring or a change of color which can be detected using optical means. In this instance, the intensity of the color is a measure of the parameter to be determined. As a measurand correlated with the parameter to be determined, an absorption or extinction of the treated sample may, for example, be determined photometrically in that electromagnetic radiation, such as visible light, is radiated from a radiation source into the liquid sample and is received by a suitable receiver after transmission through the liquid sample. The receiver generates a measurement signal which depends upon the intensity of the received radiation, from which the value of the parameter to be determined may be derived, e.g. on the basis of a calibration function or a calibration table.

Given photometric analyzers, regular calibration of the measuring apparatus is necessary in order to obtain correct and reliable measured values. A 2-point calibration is thereby usually performed given process analyzers. With a zero standard, the measured value for a sample with an analyte concentration of “0” (rarely also with a known, low concentration) is determined. With a calibration standard, the measured value for a sample with a known analyte concentration is determined. The two factors of the calibration line (zero offset, slope) can be calculated from the two measured values and the two known concentrations.

In principle, two basic problems result from this:

Two operating liquids are necessary which, for an automatic calibration, must be stored and replaced in or at the device. This increases the space requirement, maintenance effort, and logistic effort.

For an automatic calibration, the device requires a connection for the two liquids. This increases the hardware costs for connecting and conveying two liquids.

US 2007/0037289 A1 does, in fact, disclose a method for calibrating the zero point of a device which serves to determine the amount of silicate contained in a sample of a silicic acid solution to be analyzed with the aid of a colorimetric method. This colorimetric method consists of introducing the following components into the sample successively: a molybdate solution, a developer, and a reagent. In order to determine the zero point, the developer is first introduced into the sample of the silicate solution to be measured, followed by the molybdate solution, and finally reducing agent. However, the problems described above are not solved; several liquid containers are still necessary.

### SUMMARY

The present disclosure is based on the object of proposing a 2-point calibration in a simple and safe manner.

The object is achieved by a method comprising the steps of: detecting a first measurement point, with the steps of adding a first reagent to a sample of a first calibration standard, adding a second reagent to this sample, adding a third reagent to this sample; detecting a second measurement point, wherein the second measurement point differs from the first measurement point, with the steps of adding the second reagent to a sample of a second calibration standard, adding the first reagent to this sample, adding a third reagent to this sample; determining the zero point and the slope of the calibration line using the first and second measurement point.

One embodiment provides that the first reagent contains a citric acid solution, the second reagent contains a sulfuric acid molybdate solution, and the third reagent contains an aminonaphthol sulfonic acid solution.

The claimed method thus enables a 2-point calibration to be performed with only one calibration liquid. This enables simpler operation for the customer, since only one operating fluid is necessary. Lower device costs arise since one fewer connection is necessary. The zero value and the slope of the calibration line are determined using only one standard. This enables simpler maintenance and avoids sources of errors.

One embodiment provides that the second calibration standard is the same calibration standard as the first calibration standard.

One embodiment provides that the first measurement point corresponds to the zero point.

One embodiment provides that the method further comprises the step of: detecting a third measurement point, with the steps of adding the second reagent to a sample of the first calibration standard, adding the first reagent to this sample, adding a third reagent to this sample.

One embodiment provides that the same calibration standard with a known concentration, which differs from the calibration standard of the second measurement point, is used for determining the first and third measurement point.

One embodiment provides that the method further comprises the step of: determining the calibration line step by step, by means of the first, second and third measurement point.

One embodiment provides that the method further comprises the steps of: determining the zero point and the slope of the calibration line using the first and third measurement point, checking whether the second measurement point is on the calibration line.

This is explained in more detail below with reference to FIG. 1.

### BRIEF DESCRIPTION OF THE DRAWING

FIG. 1 shows a claimed automatic analyzer in a symbolic overview.

### DETAILED DESCRIPTION

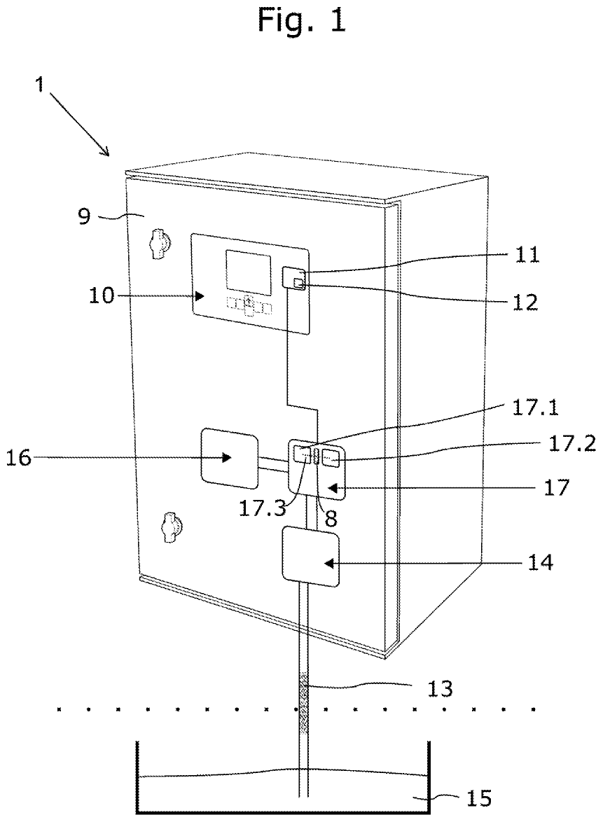

The entirety of the claimed automatic analyzer is denoted by reference sign 1 and is shown in FIG. 1.

To be measured is, for example, the direct absorption of a substance or the intensity of a coloring which is generated by converting the substance to be determined into a color complex by means of reagents. Further possible measurands that function according to a similar principle are turbidity, fluorescence etc. An application example is the COD measurement (chemical oxygen demand, COD), wherein COD is a sum parameter, which means that the measured value results from the sum total of the substances and cannot be associated with a single substance. In this measurement method, a change of color is generated in a reactor; see below. Further possible parameters are, for instance, total carbon, total nitrogen, or an ion concentration, such as the concentration of the ions of ammonium, phosphate, nitrate etc. In the present application, the focus is on the determination of silicate.

A sample 13 is taken from the medium 15 to be analyzed, for example, a liquid or a gas. Usually, taking the sample 13 happens fully automatically by means of the analyzer itself, for instance via subsystems 14 such as pumps, tubes, valves etc. For determining the substance content to be determined of a certain species, one or more reagents 16 that were developed specifically for the respective substance content and that stored so as to be available in the analyzer housing 9 are mixed with the sample 13 to be measured. This is shown in a symbolic manner in FIG. 1. In reality, various vessels are provided with different reagents, which are extracted by means of the aforementioned pumps, tubes, valves etc. and mixed as necessary.

A color reaction of the mixture caused in this way is subsequently measured by means of an appropriate measuring device, such as a photometer 17. For this purpose, the sample 13 and the reagents 16 are, for example, mixed in a measuring chamber 8 and optically measured with light of at least one wavelength using the transmitted light method. In the method, light is transmitted through the sample 13 by means of an emitter 17.1. A receiver 17.2 for receiving the transmitted light is associated with the emitter 17.1, wherein an optical measuring path 17.3 (indicated by a dotted line in FIG. 1) runs from the emitter 17.1 to the receiver 17.2. The emitter 17.1 comprises, for example, one or more LEDs, i.e. one LED per wavelength, or an appropriate light source with broadband excitation. Alternatively, a broadband light source with a corresponding filter placed in front of it is used, which filter can also, depending on the application, be mounted directly in front of the receiver. The receiver 17.2 can, for example, comprise one or more photodiodes.

The measured value is generated by the receiver on the basis of the light absorption and a stored calibration function. The analyzer 1 comprises a transmitter 10 with a microcontroller 11 along with a memory 12. The analyzer 1 can be connected to a field bus via the transmitter 10. Furthermore, the analyzer 1 is controlled via the transmitter 10. Thus, the extraction of a sample 13 from the medium 15 is, for example, initiated by the microcontroller 11 by means of appropriate control commands to the subsystems 14. The measurement by the photometer 17 is also controlled and regulated by the microcontroller. The dosing of the sample 13 can also be controlled by the transmitter 10. A computer program for controlling the analyzer, for instance for dosing, then runs on the transmitter 10. A computer-readable medium is also located at or can be plugged into the transmitter 10.

The extraction of the sample 13 is now described in principle. To extract the sample 13 from the medium 15, a sample taking apparatus is used that can, for example, comprise a pump, such as a peristaltic pump. The sample 13 passes into a dosing apparatus via a medium line. As mentioned, the analyzer 1 comprises liquid containers that contain reagents 16 to be added to the sample 13 for determining the measurand of the analyzer 9, and standard solutions for calibrating and/or adjusting the analyzer 1. The peristaltic pump pumps the sample 13 into the dosing apparatus.

As mentioned above, given photometric process analyzers 1, the analyte is converted by means of one or more reagents 16 into an optically quantifiable dye. The more intense the color of the dye (higher absorption at the corresponding wavelength), the higher (rarely also lower) the concentration of the analyte. Depending on the method, intermediate reactions are often necessary to produce the detectable dye.

Silicates are the salts and esters of orthosilicic acid (Si(OH)4) and the condensates thereof. The oxygen acids of silicon are referred to as silicic acids. The simplest silicic acid is monosilicic acid (orthosilicic acid). Silicon is the second most common element in the earth's crust, at 18%. It occurs in many minerals in chemically bonded form, as silicate or silicon dioxide. It is washed out of these rocks in small amounts as silicic acid or silicate and thus passes into bodies of water. In the field of drinking water, there are no reference values for the silicate content since no harmful effects are known. By contrast, boiler feed water and boiler water must have only a low silicate concentration, since insoluble silicon dioxide forms under thermal stress and high pressure. This deposits on the inner boiler walls, in heat exchangers and turbine blades, thereby reducing the efficiency of the heat exchangers or leading to overheating.

Silicates, such as silicic acid, are to be determined by means of the device described in the application. In general, the claimed method is to be used to calibrate devices for photometric determination of dissolved silicates with a low degree of condensation (including orthosilicic acid).

The molybdenum blue method is used for photometric determination. Silicate and phosphate thereby react in an acidic medium with molybdate to form yellow silicomolybdic acid complexes and phosphomolybdic acid complexes. Addition of citric acid leads to the destruction of the phosphate complex. In the final step, an amino acid is added which reduces the yellow silicomolybdate to an intensively blue-colored silicomolybdenum blue. The absorption is measured at a wavelength of 830 nm. The intensity of the absorption of the light is proportional to the silicate concentration in the sample.

This is described in more detail below.

In order to determine silicic acid, dissolved silicic acid (and orthophosphate) is first converted by means of a reagent into the silicomolybdic acid (and phosphomolybdic acid) (for the purposes of this application, this is the second reagent). The phosphomolybdic acid is destroyed reductively by means of a further reagent (this is the first reagent for the purposes of this application). By means of a further reagent, the silicomolybdic acid is converted into the optically very dense and readily detectable molybdenum blue (for the purposes of this application, this is the third reagent). A first measurement point is thus determined.

For the determination of the silicic acid, there is a method in which the formation of the intermediate dye (silicomolybdic acid) is suppressed, which can advantageously be utilized in calibration. A second measurement point can thereby be determined.

First, the acidic first reagent is added. After the subsequent addition of the second reagent, the formation of silicomolybdic acid (and phosphomolybdic acid) is suppressed by the low pH value. As a result, no silicomolybdic acid is formed after addition of the third reagent 3. Consequently, the same measurement signal always arises, independently of the silicate concentration in the sample to be analyzed.

The silicomolybdic acid does not form at too low a pH value or in the presence of weak reducing agents. In the zero-point calibration, this can be used to prevent any residual silicates from reacting out in the blank water, so that only the theoretical intrinsic absorption of the reaction mixture is measured with an absolutely silicate-free sample.

The correct zero value can thus be determined, even if the zero standard (for example due to impurities or manufacturing inaccuracies) has a silicic acid concentration of >0.

According to the claims, the calibration standard is now used intentionally to determine the zero value according to the procedure described above, whereby the slope is ultimately also determined from the same standard.

Thus, both calibration factors are determined with only one standard:

1) Determining the zero value from the calibration standard by changing the reagent sequence (first measurement point).

2) Determining the calibration value: performing a normal calibration measurement (second measurement point).

3) Calculating the two factors of the calibration line (zero offset, slope) from the measurement points obtained in steps 1 and 2.

The order in which the two measurement points are determined is not important. The order of steps 1) and 2) can also be swapped.

In addition, the method is also suitable for minimizing susceptibility to error and reducing operating costs. Since zero standard is easily contaminated, or can only be manufactured, transported, and stored in sufficient purity with difficulty, a lot of effort and high costs, error sources can be suppressed. The manufacturing requirements are reduced. Operating errors are suppressed if the zero measurement is performed with calibration standard. The zero standard can be produced by the customer even if the available water does not have sufficient purity under normal circumstances.

The first reagent contains a citric acid solution. The second reagent contains a sulfuric acid molybdate solution, and the third reagent contains an aminonaphthol sulfonic acid as reducing agent.

In addition, the method is also suitable for performing an apparatus testing:

For this, a first standard with a known concentration of >0 is used for apparatus testing, as well as a second calibration standard. The following steps are performed:

1) Determining the zero value by changing the reagent sequence from the first standard (first measurement point).

2) Determining the calibration value: Performing a normal calibration measurement from the second calibration standard (second measurement point).

3) Determining the control point: Performing a normal calibration measurement from the first standard (third measurement point).

4) Checking whether the third measurement point is on the calibration line, wherein the factors of the calibration line (zero offset, slope) have been obtained from the measurement points obtained in steps 1 and 2.

The order in which the three measurement points are determined is not important and can be changed.

The calibration line (zero offset, slope) may also have been obtained from the measurement points obtained in steps 1) and 3), and the measurement point obtained in step 2) may be used as the control point.

The present application thus describes two methods for calibration.

The first method describes the determination of the calibration line with one and the same standard.

The second method describes the determination of the calibration line with two calibration standards:

The first calibration standard preferably has a low concentration (e.g. 5-10 μg/l), and the second calibration standard has a calibration concentration of, e.g., 50 μg/l. Three measurements are performed with the two calibration standards:

a. Zero measurement with the low (first) calibration standard and the method with the reagent sequence of first reagent, second reagent, third reagent

b. Measurement with the (second) calibration standard and the reagent sequence of second reagent, first reagent, third reagent

c. Control measurement with the low (first) calibration standard and the reagent sequence of second reagent, first reagent, third reagent

In principle, however, the order of the three measurements a., b., c. does not matter.

The calibration line is then formed from the measurements a. and b.

Finally, it is possible to check whether the measurement c. is on the calibration line. An apparatus testing may thus additionally be performed with only two calibration standards. Normally, 3 standards are required to do this.

Alternatively, two calibration lines can also be formed from the three points.

1. A method for calibrating a photometric analyzer which is designed to determine the silicate content of an analyte, comprising the steps of:
detecting a first measurement point, with the steps of:
adding a first reagent to a sample of a first calibration standard;
adding a second reagent to this sample; and
adding a third reagent to this sample; and
detecting a second measurement point, wherein the second measurement point differs from the first measurement point, with the steps of:
adding the second reagent to a sample of a second calibration standard;
adding the first reagent to this sample; and
adding a third reagent to this sample; and
determining the zero point and the slope of the calibration line using the first and second measurement point.

2. The method according to claim 1, wherein:
the first reagent contains a citric acid solution;
the second reagent contains a sulfuric acid molybdate solution; and
the third reagent contains an aminonaphthol sulfonic acid solution.

3. The method according to claim 1, wherein the second calibration standard is the same calibration standard as the first calibration standard.

4. The method according to claim 1, wherein the first measurement point corresponds to the zero point.

5. The method according to claim 1, further comprising the step of:
detecting a third measurement point, with the steps of:
adding the second reagent to a sample of the first calibration standard;
adding the first reagent to this sample; and
adding a third reagent to this sample.

6. The method according to claim 5, wherein the same calibration standard with a known concentration, which differs from the calibration standard of the second measurement point, is used for determining the first and third measurement point.

7. The method according to claim 6, further comprising the step of:
determining the calibration line step by step, using the first, second, and third measurement point.

8. The method according to claim 6, further comprising the steps of:
determining the zero point and the slope of the calibration line using the first and third measurement point; and
checking whether the second measurement point is on the calibration line.
